(19) United States
(12) Patent Application Publication
(10) Pub. No.: US 2026/0278911 A1
(43) Pub. Date: Sep. 17, 2026

(54) METHODS, STORAGE MEDIA, AND SYSTEMS FOR ITERATIVELY TEXTURING A THREE-DIMENSIONAL MODEL WITH CONSISTENT PREDICTIONS

(71) Applicant: Hover Inc., San Francisco, CA (US)

(72) Inventor: Jack Michael Langerman, Herndon, PA (US)

(21) Appl. No.: 19/473,086

(22) PCT Filed: Apr. 24, 2024
(86) PCT No.: PCT/US2024/026069

§ 371 Date: Oct. 6, 2025

Related U.S. Application Data
(60) Provisional application No. 63/498,253, filed on Apr. 25, 2023.
(60) Provisional application No. 63/462,911, filed on Apr. 28, 2023.
(60) Provisional application No. 63/614,380, filed on Dec. 22, 2023.
(60) Provisional application No. 63/637,703, filed on Apr. 23, 2024.

(51) Int. Cl. G06T 15/04; G06T 19/20; G06V 10/26; G06V 10/764

(52) U.S. Cl. CPC G06T 15/04; G06T 19/20; G06T 2200/24; G06T 2210/04; G06T 2219/004; G06T 2219/2012; G06T 2219/2016; G06V 10/26; G06V 10/764

(57) ABSTRACT

System and methods for generating similar successive predictions to a three-dimensional scene. An example method includes accessing a three-dimensional model associated with a building, the three-dimensional model being associated with geometry which is included in a scene; generating, via one or more machine learning models, a first viewpoint of the scene from a first viewpoint angle, the first viewpoint including textures applied to the three-dimensional model from the first viewpoint angle and additional image content generated based on at least one parameter; extracting, via one or more machine learning models, updated geometry for inclusion in the scene, wherein the updated geometry includes geometry associated with the additional image content at the first viewpoint angle; and generating, via one or more machine learning models, a second viewpoint of the scene from a second viewpoint angle, where generating the second viewpoint is based on the updated geometry.

### CROSS-REFERENCE TO RELATED APPLICATIONS

This application claims priority to U.S. Prov. Patent App. No. 63/498,253 titled “METHODS, STORAGE MEDIA, AND SYSTEMS FOR GENERATING SIMILAR SUCCESSIVE PREDICTIONS TO A THREE-DIMENSIONAL SCENE” and filed on Apr. 25, 2023. This application further claims priority to U.S. Prov. Patent App. No. 63/462,911 titled “METHODS, STORAGE MEDIA, AND SYSTEMS FOR ITERATIVELY TEXTURING A THREE-DIMENSIONAL MODEL WITH CONSISTENT PREDICTIONS” and filed on Apr. 28, 2023. This application further claims priority to U.S. Prov. Patent App. No. 63/614,380 titled “METHODS, STORAGE MEDIA, AND SYSTEMS FOR GENERATING ADDITIONAL GEOMETRY VIA SUCCESSIVE PREDICTIONS IN A THREE-DIMENSIONAL SCENE” and filed on Dec. 22, 2023. This application further claims priority to U.S. Prov. Patent App. No. 63/637,703 titled “METHODS, STORAGE MEDIA, AND SYSTEMS FOR ITERATIVELY TEXTURING A THREE-DIMENSIONAL MODEL WITH CONSISTENT PREDICTIONS” and filed on Apr. 23, 2024. Each of the above-recited applications is hereby incorporated herein by reference in its entirety.

### TECHNICAL FIELD

The present disclosure relates to methods, storage media, and systems for generating similar successive predictions to a three-dimensional scene.

### BACKGROUND

Current generative machine learning models predict new visual data according to wholesale predictions and successive predictions therefore produce wholly new outputs. For a limited field of view of a three-dimensional object, such as through a two-dimensional image plane of a viewer, this can result in predictions applied to a first part of the three-dimensional model bearing little visual consistency with a subsequent prediction applied to a new view.

### SUMMARY

Attempts to address this consistency problem still produce undesirable results. Some prior art techniques provide a generative machine learning model with a plurality of views of a three-dimensional model at the time of inference and provide generated visual information across all provided views as a single output (e.g., single inference/prediction according to all views). In other words, the “back” of a three-dimensional model has visual information generated at the same time as the “front.” In such use cases, the prediction is still wholesale. Other prior art techniques apply surface modifications, such as homographies, to the three-dimensional object to recreate the three-dimensional object in a new format. For example, the three-dimensional object can be “unfolded” to a single two-dimensional plane and the visual information applied to the two-dimensional object wholesale (e.g., single inference/prediction according to an artificial view of all data) before re-folding to the original three-dimensional geometry. Both techniques continue to apply a global prediction to an otherwise multi-view object such as a three-dimensional model.

As a result, they suffer from two practical limitations. First, they impute the information of the three-dimensional model that would otherwise only be viewable from certain views (such as different geometry or new scene data otherwise) into the inference and output for the three-dimensional model for any one view. An analogy to home design would be a designer preparing a mockup of a home renovation, where the front door is a garage door. Secondly, interaction of discrete elements is not possible, as each prediction is global. An analogy to home design is a designer preparing a mockup of a home renovation, and the homeowner liking the doors' aesthetic but asking for new window dressing and the designer prepares a new mockup with new doors and windows.

Some prior art techniques address keeping similarity for subsequent predictions in two-dimensional images. These techniques assume a base two-dimensional image, then predict new pixels to fill portions that have been removed (a technique referred to as inpainting) or provide additional pixels to portions on the edges to expand the two-dimensional image (a technique referred to as outpainting). Both techniques rely on the underlying reference data (e.g., the two-dimensional image) and the camera viewing the reference data to remaining consistent before and after the prediction. For example, the viewing camera does not undergo rotations for subsequent predictions. Otherwise, as the extrinsics for a viewing camera change, or the visual information of the reference data is modified, the prediction is applied to ever increasing divergence from the original item. There is no new information for a two-dimensional image to provide for a new three-dimensional perspective view; the original two-dimensional data has a new interpretation for the inpainting/outpainting network because it is not acting upon inherently three-dimensional information. Further shortcomings of two-dimensional data in three-dimensional viewing operations are the cropping of original data, or implausible warping as the two-dimensional image plane is forced to fit a three-dimensional coordinate to a two-dimensional system; these and other problems with manipulating two-dimensional data in three-dimensional operations are explained further in U.S. Provisional application 63/313,257, the contents of which are incorporated by reference. Accordingly, applying these two-dimensional techniques to new three-dimensional perspectives has diminishing material of the original to base the next prediction on. In other words, the next prediction is meant to mimic the original scene, but each extrinsic change alters the original scene information without replacing it with anything new. In such scenarios, inpainting and outpainting would be forced to predict new content for a new scene, not the original scene.

The problem of generative machine learning models' distinct, randomized outputs for successive inferences across a three-dimensional object from different viewpoints may be solved by selectively texturing new regions and geometries from new viewpoints of the three-dimensional model according to preserved visual information. Selective texturing enables generation of discrete predictions more fully responsive to an instant view and the unique geometry it presents, while still maintaining consistency with visual data generated for other views. In this way, a prediction for the front of a house is not influenced by the geometry of the back of the house, but the visual context of the back of the house may influence a prediction of the visual aspects of the front of the house.

One aspect of the present disclosure relates to a method for iteratively texturing a three-dimensional model with consistent predictions. The method may include providing a three-dimensional model. The method may include generating a first texture for the three-dimensional model from a first viewpoint perspective. The first texture may be generated via one or more machine learning models and at least one first parameter. The method may include texturing a select portion of the three-dimensional model with the first texture. The method may include applying a viewpoint change to the three-dimensional model. The method may include generating an extension texture for the three-dimensional model from the viewpoint change. The extension texture may be generated via one or more machine learning models and at least one second parameter. The method may include texturing an expanded portion of the three-dimensional model with the extension texture. The method may include displaying the three-dimensional with the first texture and extension texture.

Another aspect of the present disclosure relates to a non-transient computer-readable storage medium having instructions embodied thereon, the instructions being executable by one or more processors to perform a method for iteratively texturing a three-dimensional model with consistent predictions. The method may include providing a three-dimensional model. The method may include generating a first texture for the three-dimensional model from a first viewpoint perspective. The first texture may be generated via one or more machine learning models and at least one first parameter. The method may include texturing a select portion of the three-dimensional model with the first texture. The method may include applying a viewpoint change to the three-dimensional model. The method may include generating an extension texture for the three-dimensional model from the viewpoint change. The extension texture may be generated via one or more machine learning models and at least one second parameter. The method may include texturing an expanded portion of the three-dimensional model with the extension texture. The method may include displaying the three-dimensional with the first texture and extension texture.

Yet another aspect of the present disclosure relates to a system configured for iteratively texturing a three-dimensional model with consistent predictions. The system may include one or more hardware processors configured by machine-readable instructions. The processor(s) may be configured to provide a three-dimensional model. The processor(s) may be configured to generate a first texture for the three-dimensional model from a first viewpoint perspective. The first texture may be generated via one or more machine learning models and at least one first parameter. The processor(s) may be configured to texture a select portion of the three-dimensional model with the first texture. The processor(s) may be configured to apply a viewpoint change to the three-dimensional model. The processor(s) may be configured to generate an extension texture for the three-dimensional model from the viewpoint change. The extension texture may be generated via one or more machine learning models and at least one second parameter. The processor(s) may be configured to texture an expanded portion of the three-dimensional model with the extension texture. The processor(s) may be configured to display the three-dimensional with the first texture and extension texture.

Another aspect of the present disclosure relates to a method. The method includes accessing a three-dimensional model associated with a building, the three-dimensional model being associated with geometry which is included in a scene; generating, via one or more machine learning models, a first viewpoint of the scene from a first viewpoint angle, the first viewpoint including textures applied to the three-dimensional model from the first viewpoint angle and additional image content generated based on at least one parameter; extracting, via one or more machine learning models, updated geometry for inclusion in the scene, wherein the updated geometry includes geometry associated with the additional image content at the first viewpoint angle; and generating, via one or more machine learning models, a second viewpoint of the scene from a second viewpoint angle, where generating the second viewpoint is based on the updated geometry.

Another aspect of the present disclosure relates to non-transitory computer-readable storage media having instructions embodied thereon, the instructions being executable by one or more processors to perform operations. The operations may include accessing a three-dimensional model associated with a building, the three-dimensional model being associated with geometry which is included in a scene; generating, via one or more machine learning models, a first viewpoint of the scene from a first viewpoint angle, the first viewpoint including textures applied to the three-dimensional model from the first viewpoint angle and additional image content generated based on at least one parameter; extracting, via one or more machine learning models, updated geometry for inclusion in the scene, wherein the updated geometry includes geometry associated with the additional image content at the first viewpoint angle; and generating, via one or more machine learning models, a second viewpoint of the scene from a second viewpoint angle, where generating the second viewpoint is based on the updated geometry.

Yet another aspect of the present disclosure relates to a system. The system may include one or more computers and non-transitory computer storage media storing instructions that when executed by the one or more computers cause the one or more computers to perform operations. The operations may include accessing a three-dimensional model associated with a building, the three-dimensional model being associated with geometry which is included in a scene; generating, via one or more machine learning models, a first viewpoint of the scene from a first viewpoint angle, the first viewpoint including textures applied to the three-dimensional model from the first viewpoint angle and additional image content generated based on at least one parameter; extracting, via one or more machine learning models, updated geometry for inclusion in the scene, wherein the updated geometry includes geometry associated with the additional image content at the first viewpoint angle; and generating, via one or more machine learning models, a second viewpoint of the scene from a second viewpoint angle, where generating the second viewpoint is based on the updated geometry.

Another aspect of the present disclosure relates to a method implemented by a system of one or more processors with the system generating a user interface for presentation via a user device. The user interface requests a textual or visual prompt indicative of features to be included in a three-dimensional scene, and receives input of a three-dimensional model associated with a building; triggers generation of viewpoints of the scene from a plurality of viewpoint angles, wherein the viewpoints represent image rendering of the scene, and wherein the three-dimensional model is associated with geometry, wherein the system is configured to: generate, via one or more machine learning models, individual viewpoints from individual viewpoint angles, wherein the machine learning models are input textures applied to geometry which form the scene from an individual viewpoint angle, wherein the geometry is determined using the three-dimensional model and geometry extracted from additional image content generated using the machine learning models for one or more prior viewpoint angles; and presents at least one of the viewpoints

Another aspect of the present disclosure relates to a method implemented by a system of one or more processors. The method may include accessing a three-dimensional model associated with a building, the three-dimensional model being associated with geometry and semantic labels; generating, via one or more machine learning models, textures to be applied to the three-dimensional model, wherein generating textures is based on at least one parameter, and wherein the parameter is analyzed to identify particular semantic labels which are input into the one or more machine learning models; in response to a viewpoint change, extracting, via one or more machine learning models, updated geometry based on the generated textures and the geometry associated with the three-dimensional model, wherein the updated geometry includes additional geometry reflective of a portion of the textures associated with the at least one parameter; and generating, via one or more machine learning models, textures to be applied to the updated geometry.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A is a block diagram of an example building generation system generating a three-dimensional scene with geometry based on a prompt.

FIG. 1B is a block diagram of the example building generation system generating an extension texture.

FIG. 1C is an example user interface of a building model associated with an interior of a building.

FIG. 2A illustrates a system configured for iteratively texturing a three-dimensional model with consistent predictions.

FIG. 2B is a flowchart of an example process for iteratively texturing a three-dimensional model with consistent predictions.

FIG. 3A is another block diagram of the example building generation system generating a three-dimensional scene with geometry based on a prompt.

FIG. 3B is a detailed block diagram of the example building generation system.

FIG. 4 is a flowchart of an example process for generating a three-dimensional scene based on a prompt indicating additional geometry for inclusion in the three-dimensional scene.

FIG. 5 is a block diagram of the building generation system generating a textured building based on a semantic prompt.

FIG. 6 is a flowchart of an example process for generating textures to update a building based on a semantic prompt.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction

This application describes techniques to generate, and optionally render, views of a three-dimensional scene that includes a model of an exterior, or interior, of a building (collectively referred to herein as a building model). For example, a building may represent a domicile. In this example, a building model may be provided to a system described herein (e.g., the building generation system 100), with the building model including geometry of the building (e.g., depth information). An example building model may include a depth map, a computer aided design (CAD) model, a mesh that forms the building model, and so on.

As will be described, features may be indicated which are to be included in the three-dimensional scene. Example features may relate to updated textures or other visual information to be applied to the building model. As an example, an exterior of the building may be updated to depict the building in a different architectural style or with different physical features (e.g., wood, stucco, and so on). As another example, example features may be associated with additional geometry which is to be included in the scene. As an example, additional geometry may include landscape features positioned about the building (e.g., trees, bushes, succulents, and so on). As another example, additional geometry may include interior features to be included (e.g., an island to be included in a kitchen). The system may then use machine learning techniques to generate the features such that the three-dimensional scene may be viewed at arbitrary viewing angles.

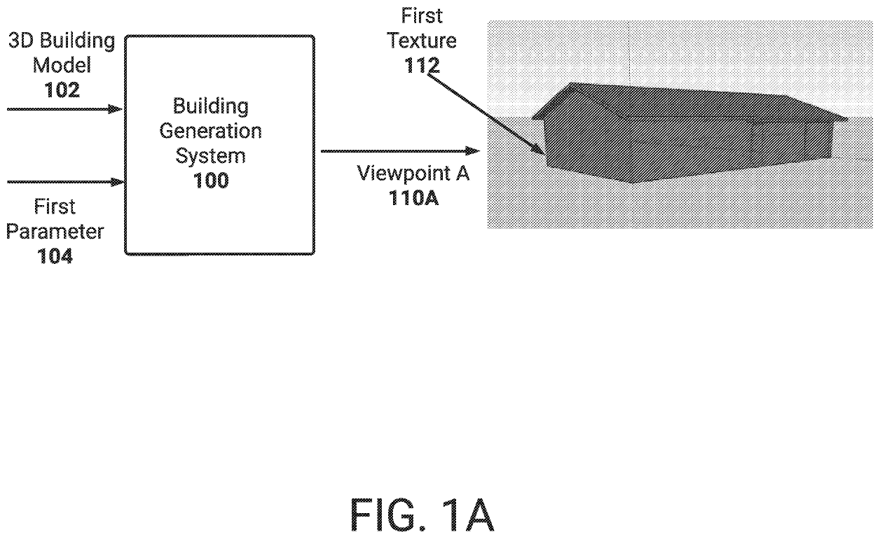

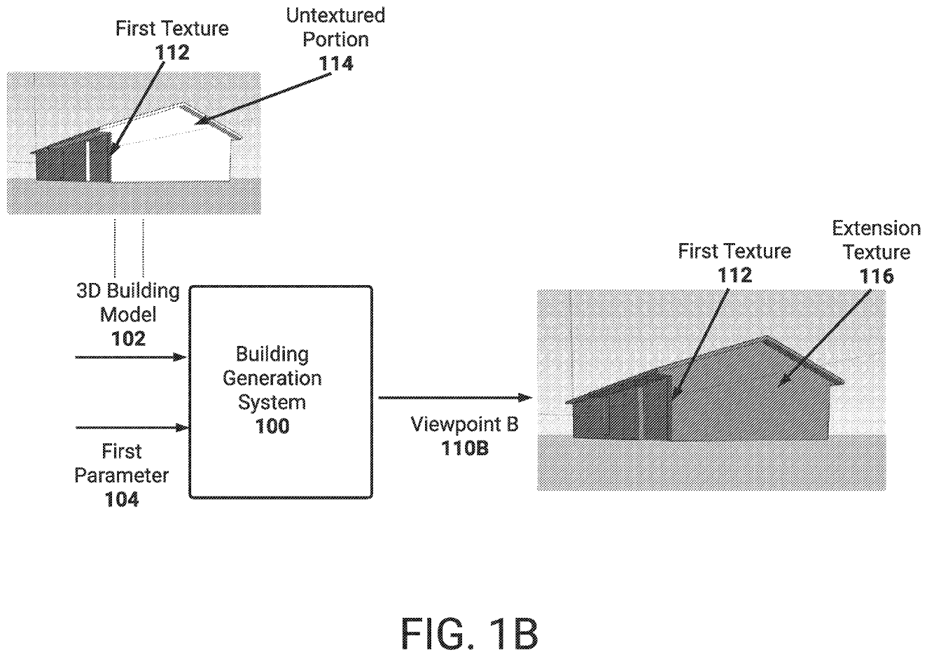

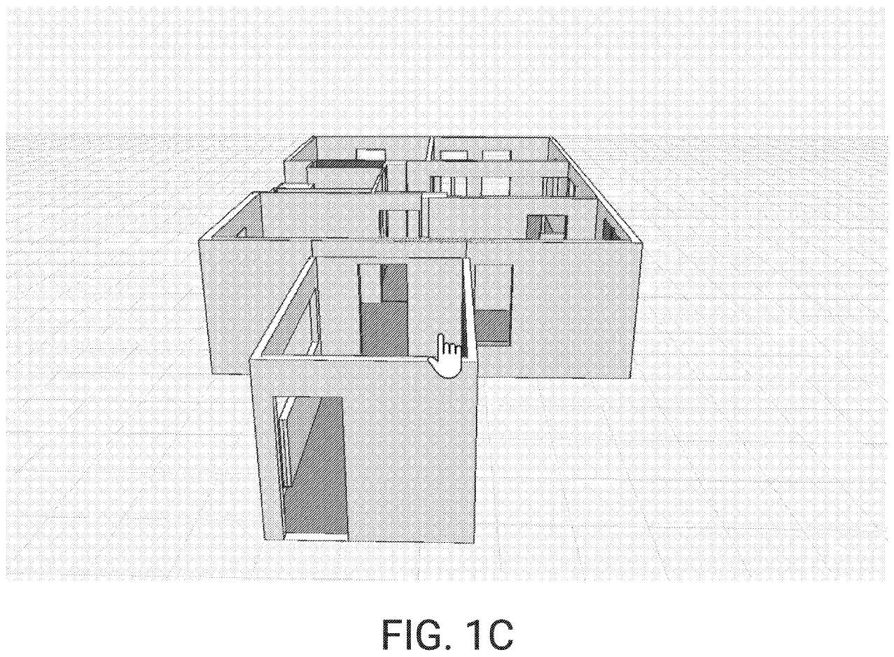

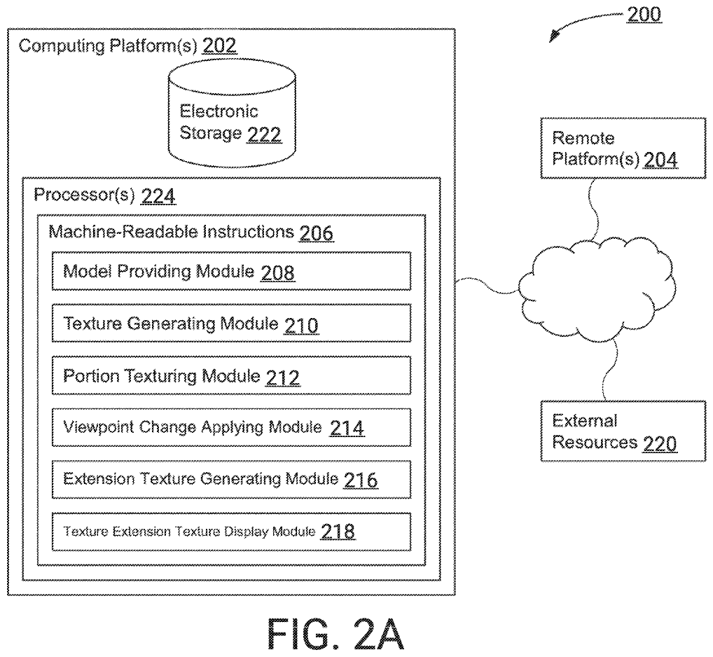

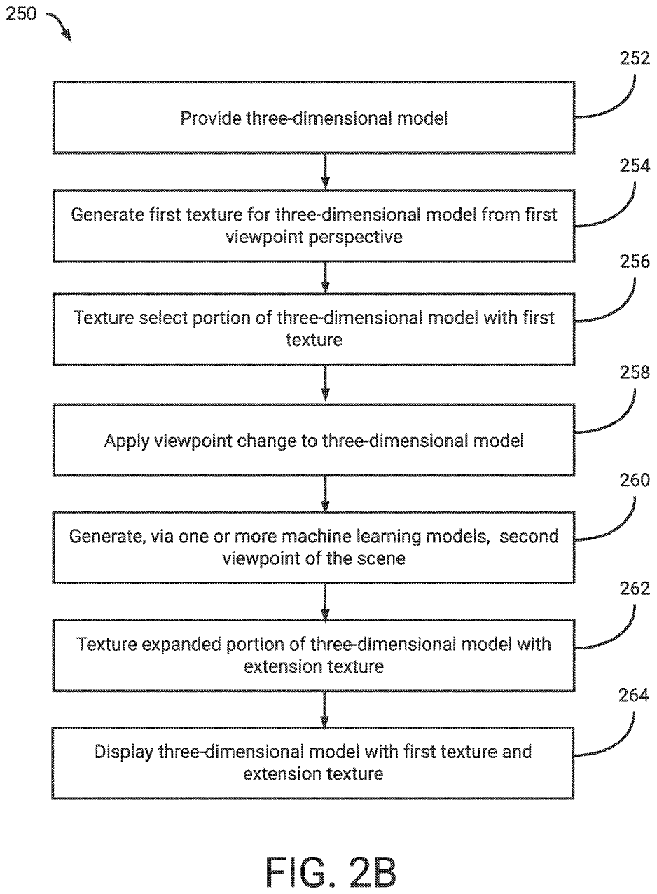

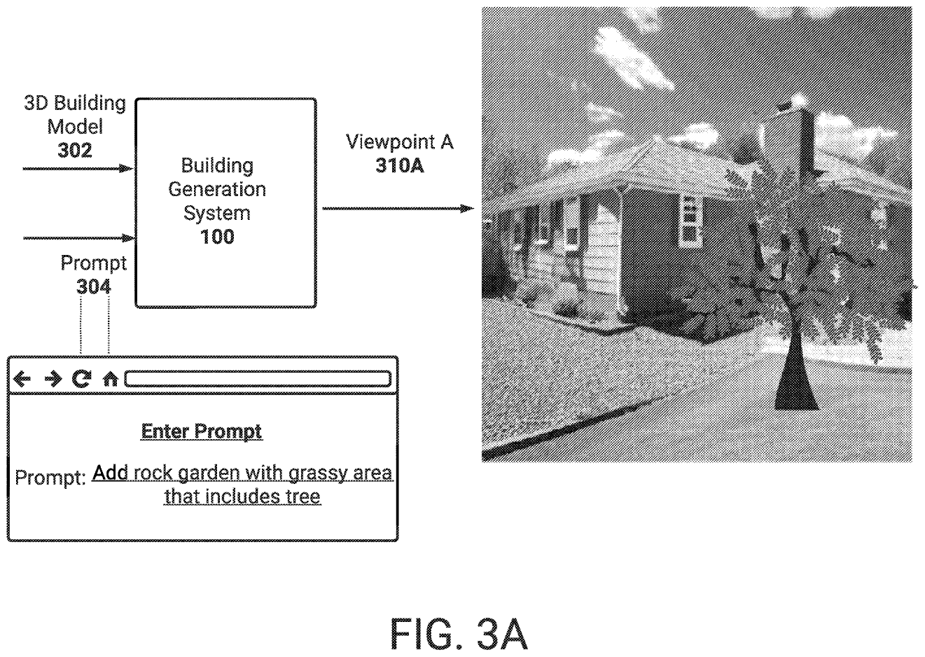

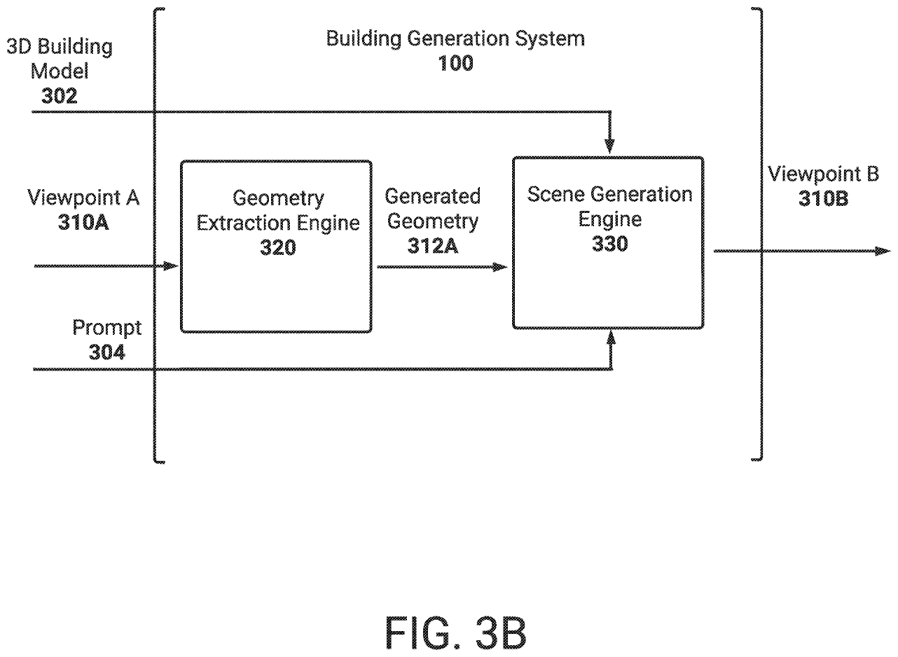

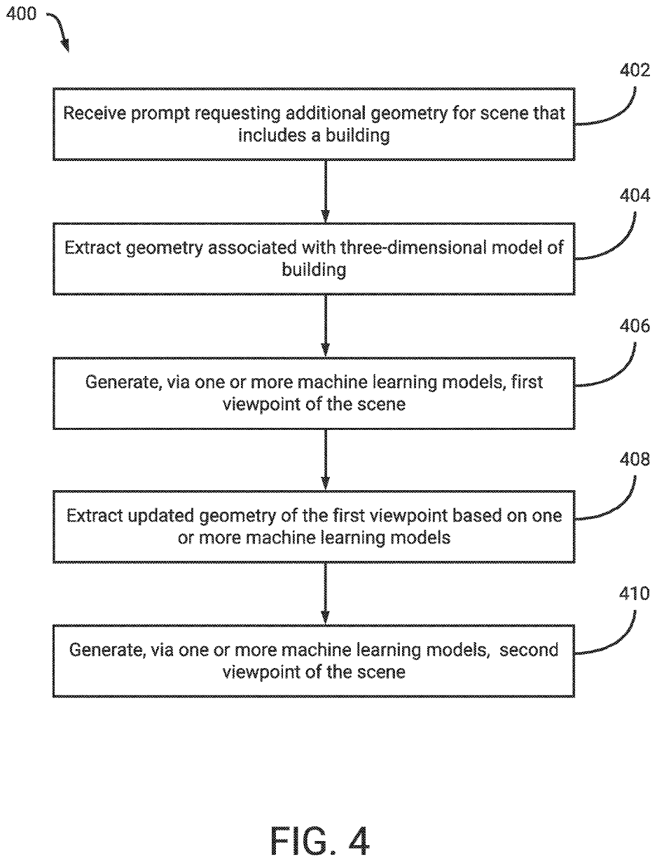

Advantageously, the techniques described herein may leverage machine learning techniques to form the three-dimensional scene from a multitude of viewpoint angles of the building model. For example, the system may render the building model from a viewpoint angle, with the rendering being referred to herein as a viewpoint. At this viewpoint angle, a machine learning model may be used to add textures reflecting the features (e.g., updated building textures, updated interior textures, textures for additional geometry) to the viewpoint. Thus, the rendering may be a two-dimensional image of the building model and features from the viewpoint angle. For example, and as described in FIGS. 1A-2B, the system may generate extension textures to be applied to the building model which reflect updated visual features. Applying the textures may include, updating the information which forms the building model to add a visual texture (e.g., applying the texture to the CAD model, mesh, depth map, line map, segmentation map, and so on). As another example, and as described in FIGS. 3A-4, the system may generate extension textures which illustrate additional geometry for inclusion.

Subsequently, the system may adjust the viewpoint angle to generate a subsequent viewpoint of the building model. For example, the system may apply a viewpoint change to adjust the viewpoint angle by a threshold number of degrees. In some embodiments, the system may adjust the viewpoint via applying a translation change (e.g., a zoom effect, an adjustment in position at which a camera is viewing the building model). As will be described, the system may then add textures to untextured portions of the building model which are included in the subsequent viewpoint. In some embodiments, the machine learning techniques may generate additional textures which are consistent with, or otherwise cohesive with, the prior-textured portions.

Machine learning models which output generative visual information typically output two-dimensional images. For example, diffusion models may be used to generate two-dimensional images which are responsive to input prompts (e.g., textual prompts) optionally in combination with input images. Use of these models, absent the techniques described herein, is ill-suited to updating the appearance of a building model. For example, the building model (e.g., a user's domicile) represents a consistent three-dimensional structure (e.g., the exterior of the domicile, an interior room or portion of the structure). However, at present such generative machine learning models are limited to generating discrete images thus severing the consistency of updates made to the three-dimensional structure.

The disclosed technology addresses the above-described technical shortcomings and enables accurate updating of a building model while maintaining visual consistency about the building model. For example, a user's domicile may be updated to match a particular architectural style. In this example, textures of the user's domicile may match the particular architectural style in a seamless visual manner as the user rotates the domicile in a user interface. As another example, an interior may be updated to match a particular style. As another example, the building model's geometry may be adjusted and/or new geometry included. For this example, the disclosed technology will all the adjusted and/or new geometry to have a consistent visual appearance with consistent underlying geometry.

### Introduction—Geometry Adjustment

As described herein, the system may use machine learning techniques to adjust the geometry of a building model. For example, underlying geometry of a user's domicile may be adjusted to add a new balcony, a new porch, new landscape features, a new kitchen feature, a new staircase, and so on. Similar to generating textures for a building model, the system may generate a viewpoint (e.g., a rendering) of a building model for a particular viewing angle of a three-dimensional scene. Using machine learning techniques, the system may update the viewpoint to include, at least, textures for the adjusted geometry. For example, the textures may include landscape features. Since this rendering lacks geometry for the features (e.g., depth information), the system may use a machine learning model to extract additional geometry for the features included in the viewpoint. In this way, the system may update the three-dimensional scene to add the additional geometry for the viewpoint angle. The additional geometry will be oriented relative to the building model in the three-dimensional scene for the viewpoint angle.

Since the additional geometry was extracted at the viewpoint angle, and not yet for other viewpoint angles, the additional geometry is incomplete in the three-dimensional scene. The system may incrementally, or successively, adjust the viewpoint angle of the building model. For each adjustment, the system may render the features at the corresponding viewpoint. Additionally, the system may extract additional geometry for the features at that viewpoint angle which supplements the extracted additional geometry from prior viewpoint angles. In this way, the system may form more complete additional geometry of the features.

For example, a first viewpoint of the building model may be obtained. In this example, the first viewpoint may represent a view of the building model as seen by a camera (e.g., virtual camera, display camera, render camera, and so on) at a first viewpoint angle. Thus, in some embodiments, the first viewpoint may represent an image which renders the building model as seen by the camera at the first viewpoint angle. The rendering will depict the building model at the first viewpoint angle. A prompt, such as a textual prompt, a visual prompt, and the like, may be provided. The prompt describes features for inclusion in, or which adjusts, the three-dimensional scene. As described herein as an example, the prompt may identify landscape features. The first viewpoint and prompt may then be provided to a machine learning model, such as a generative machine learning model, which renders the landscape features at the first viewpoint. For example, the machine learning model may generate textures to be applied to the rendering of the building model at the first viewpoint angle. In some embodiments, the depth information for the building model may be used as a control signal. This signal may be used by the machine learning model to inform the generation of textures to be applied to the rendering of the building model at the first viewpoint angle. In this way, the three-dimensional scene may be updated to reflect the building model and landscape features at the first viewpoint.

The machine learning model may therefore output a rendered image of the building model and landscape features at the first viewpoint angle. The building model, as described herein, may be associated with geometry such as a depth map. However, the rendered landscape features may represent textures which lack geometry (e.g., depth information). Thus, in some embodiments, a machine learning model may be used to generate additional geometry (e.g., depth information) for the landscape features at the first viewpoint angle. For example, a monocular depth estimation model may be used to determine depth information for the landscape features depicted in the first viewpoint. In this way, the machine learning model may output additional geometry for the landscape features. The system may update the three-dimensional scene to add the additional geometry for the first viewpoint angle. As may be appreciated, the additional geometry will be oriented relative to the building model in the three-dimensional scene for the first viewpoint angle.

Subsequently, a viewpoint change may be registered. For example, a second viewpoint of the building model may be obtained. In this example, the second viewpoint may represent a view of the building model as seen by a camera (e.g., virtual camera, render camera, and so on) at a second viewpoint angle. Thus, in some embodiments, the second viewpoint may represent an image which renders the building model as seen by the camera at the second viewpoint angle, which in this case will include the building model and the landscape features. The rendering will depict the building model and landscape features with textures applied at the first viewpoint. Thus, the rendering will depict a view of the building model along with an incomplete view of the landscape features. To generate textures for inclusion in the second viewpoint, the system may use the above-described combined geometry, including the geometry of the building model at the second viewpoint angle and the additional geometry for the landscape features generated at the first viewpoint angle and viewed from the second viewpoint angle, as a control signal. The system may use techniques such as inpainting to generate (e.g., fill-in) textures for the landscape features which comport with the first viewpoint.

In this way, the machine learning model may render the second viewpoint image reflecting the three-dimensional scene (e.g., the building model, landscape features) which is consistent with the rendered first viewpoint. In some embodiments, a machine learning model may be used to generate additional geometry (e.g., depth information) for the landscape features at the second viewpoint angle. For example, a monocular depth estimation technique may be used to generate depth information for the landscape features depicted in the second viewpoint. In this way, the machine learning model may output additional geometry for the landscape features at the second viewpoint angle. The system may update the three-dimensional scene to add the additional geometry. The three-dimensional scene, including the additional geometry for the second viewpoint and the additional geometry for the first viewpoint, forms a more complete geometrical representation of the landscape features.

A user viewing the three-dimensional scene may provide input to rotate between the first viewpoint angle and second viewpoint angle. As described herein, the user may select a viewpoint angle between the first viewpoint angle and second viewpoint angle, and the system may interpolate between these angles to generate a corresponding viewpoint.

The system described herein may therefore cause rotation at particular viewing angles about the three-dimensional scene. For example, the system may iteratively, or successively, generate textures and geometry (e.g., landscape geometry) for the scene every 5 degrees, 10 degrees, 15 degrees, and so on, about the scene. In some embodiments, the rotation may be greater than five degrees. Once completed (e.g., a substantially 360-degree rotation), the system may obtain a three-dimensional scene that includes the building model and features indicated via the prompt. The three-dimensional scene may be viewed in a user interface, for example as renderings of the three-dimensional scene which are presented via a mobile application or web browser.

As may be appreciated, the prompt may allow viewing of a domicile with different, wholly new, or adjusted, geometry. For example, a user (e.g., an owner of a domicile) may view what their domicile looks like with trees, succulents, a rock garden, and so on, positioned about the domicile. The user may also view what their domicile looks like with a new porch, window, garage, and so on.

The above, and other, features will now be described in more detail.

### Block Diagram/Flowchart—Generating Textures

FIG. 1A is a block diagram of an example building generation system 100 generating a scene with geometry based on a first parameter 104. In some embodiments, the scene 110 may be a three-dimensional scene. As described herein, the building generation system 100 may allow for generation of scenes with content based on input of the first parameter, such as a textual or visual prompt, from a user. In some embodiments, the content may be three-dimensional content. The three-dimensional content may include a three-dimensional building model 102 and additional three-dimensional geometry generated based on the first parameter 104.

In some embodiments, the three-dimensional building model 102 may represent a model of a building (e.g., a domicile). For example, the three-dimensional building model 102 may reflect an interior, interior portion (e.g., a particular room or rooms), or exterior of the domicile. In some embodiments, the three-dimensional building model 102 may represent an arbitrary building which may be provided to the building generation system 100. The three-dimensional building model 102 may be associated with geometry, such as depth information. An example of depth information may include a depth map. Another example of depth information may include a line map. For this example, the line map may optionally be assigned particular colors which are indicative of depth or semantic features of the building. As another example, the three-dimensional building model 102 may be associated with a segmentation mask. For this example, the segmentation mask may define portions of the three-dimensional building model 102 (e.g., semantic classifications, segmentations of walls, the roof, and so on). As another example, the three-dimensional building model 102 may be a computer aided design (CAD) model or mesh that forms the geometry of the building.

The three-dimensional building model 102 may, in some embodiments, be generated by the building generation system 100 based on images of the associated building. For example, the building generation system 100 may obtain images at particular angles about the building. In this example, the building generation system 100 may form the three-dimensional building model 102 via, as an example, matching features depicted in the images (e.g., stereo matching). As another example, the building generation system 100 may obtains images of an interior of the associated building. For example, the images may represent imaging device(s) being rotated about an axis to obtain a 360-degree view of the interior (e.g., rotated in azimuth angle). As another example, the images may represent the imaging device(s) being navigated through an interior portion. In some embodiments, a machine learning model may be used to generate the three-dimensional building model 102.

In some embodiments, first parameter 104 may be provided to an input portion on an application or web page. For example, the building generation system 100 may be in communication with a system configured to provide a user interface to a user via a web page. As another example, the building generation system 100 may execute a web application to which users may communicate. The first parameter 104 may be, for example, a textual prompt that describes updates to be made to the building model 102. In some embodiments, additional or different prompts may be used and fall within the scope of the disclosure herein. For example, a visual prompt may be provided. In this example, the visual prompt may graphically indicate an appearance that the user prefers to apply to the building model 102. For example, the visual prompt may include a stylistic or architectural preference. In this example, the visual prompt may be an image or a different building or may be more abstract visual information for a machine learning model to interpret. As another example, an auditory prompt may be provided.

The building generation system 100 may execute a machine learning model to generate image content. For example, the machine learning model may represent a generative machine learning model which outputs image content. In some embodiments, the machine learning model may use a latent diffusion model. In some embodiments, the machine learning model may use other techniques (e.g., attention-based networks, convolution networks, autoencoders, generative adversarial networks, and so on). In some embodiments, the building generation system 100 may provide information to an outside system which executes the machine learning model. For example, the building generation system 100 may provide the three-dimensional building model 102 and first parameter 104 to the outside system.

As described herein, the building generation system 100 may successively generate a three-dimensional scene by registering, or otherwise adjusting, viewpoint changes of the building model 102. For example, and as illustrated, the building generation system 100 may generate a rendering of the scene (referred to as viewpoint A 110) which corresponds to an example viewpoint angle referred to as viewpoint angle A). In this example, the building generation system 100 may render the three-dimensional building model 102 at viewpoint angle A. As an example, viewpoint A 110 may represent a view which a camera would see of the three-dimensional building model 102 from viewpoint angle A (e.g., optionally from a particular height above a ground level). For example, and with respect to an exterior of a building the views may represent views which a camera would see from an external distance pointed toward the building (e.g., exterior to the building).

While the illustrated example includes the building model 102 being an exterior of a building, as described herein the building model 102 may represent an interior of a building. For example, the interior may reflect one or more rooms, such as a kitchen or bathroom of the building. In some embodiments, the viewpoints may represent views which a camera would see within a building interior pointed towards an exterior of the building. As an example, the viewpoint may reflect a view a person would see when standing within a room. In some embodiments, the viewpoints may represent views which a camera would see pointing from an exterior to an interior.

The machine learning model may output a first texture 112 at viewpoint angle A. For example, the texture 112 may be generated based on a forward pass through the machine learning model using viewpoint A 110 and the first parameter 104. In some embodiments, the texture may be based on geometry, such as depth information, of the three-dimensional building model 102. As an example, the depth information may represent a control signal used by the machine learning model to inform the generation of the texture. For example, the control signal may condition the machine learning model as known by those skilled in the art. The control signal may relate to, in some embodiments, ControlNet. The control signal may be associated with a neural network that replicates the weights of the machine learning model (e.g., a diffusion model) into both a trainable copy and a locked copy. The locked copy conserves the learned network prowess from vast image data, while the trainable copy gets trained on task-specific datasets to master conditional control. For example, the trainable and locked neural network portions (e.g., the weights) may be connected using a convolution layer (e.g., a zero-convolution layer).

In this way, the texture 112 may be consistent with the depth (e.g., contours, boundaries, and so on) of the three-dimensional building model 102. In some embodiments, the three-dimensional building model 102 may have a texture associated with it. The system 100 may therefore apply the first texture 112 to the building model 102.

As described herein, the building generation system 100 may then register, or otherwise adjust, the viewpoint angle. For example, the building generation system 100 may adjust the viewpoint angle to rotate the scene via a threshold viewpoint angle (e.g., 2, degrees, 5 degrees, 10 degrees).

FIG. 1B is a block diagram of an example building generation system 100 generating an extension texture 112 for viewpoint B 110B. In the upper left of the illustrated example, the building model 102 is depicted at viewpoint angle B (e.g., subsequent to rotation from viewpoint angle A). The first texture 112 is applied to a portion of the building model 102, with an untextured portion 114 visible. As may be appreciated, after rotating the building model 102 there may be portions of it which were not visible at viewpoint angle A.

The building generation system 100 may therefore update viewpoint B 110B to include an extension texture 116. This extension texture 116 may be included in the untextured portion 114 of viewpoint B 110B. In some embodiments, the building generation system 100 may generate the extension texture 116 via inpainting techniques. For example, the system 100 may render a texture for the pixels, or portions, of viewpoint B 110B which are include in the untextured portion 114. Similar to the above, depth information associated with the building model 302 may be used as a control signal.

The extension texture 116 may advantageously be consistent with the first texture 112 due to the machine learning model's use of inpainting techniques. Additionally, the extension texture 116 may correspond to the structure or geometry of the building model 102 through use of depth information as a control signal. While not illustrated, as may be appreciated the building model 102 may continue to be rotated and additional extension textures generated. The building model may therefore be updated to reflect a new visual appearance which is generated based on the first parameter 104.

In some embodiments, the extension texture 116 may be generated, and applied, to portions of the building model which are within a threshold distance or angular distance from a render camera associated with the viewpoint. As an example, portions of the building model which are further than a threshold distance metric may not have an extension texture updated. These portions may have extension textures updated as the rotation of the viewpoint angle brings these portions closer to the render camera.

In some embodiments, portions of the building model 102 may be updated while other portions are not updated. For example, the building model 102 may be semantically segmented such that it has distinction portions (e.g., semantic labels, the portions may correspond to segmentation asks associated with the semantic labels). With respect to an exterior of a building, the building model 102 may have walls, a roof, a gable, a porch, a balcony, and so on. With respect to an interior of the building, the building model 102 may have cabinets, stairs, walls, ceilings, doors, fireplaces, kitchen islands, and so on. The first parameter 104 may be used to update the visual appearance of one or more of these portions. For example, the user may identify that only a subset of the portions is to be updated. In this example, the system 100 may update textures that correspond only to the portions of the building model 102 associated with particular semantic labels. As another example, the user may identify that only a subset of the portions is not to be updated. For example, the user may like a particular roof style and the system may update other semantic labels.

FIG. 1C is an example user interface of a building model associated with an interior of a building. As described above, in some embodiments the building model may represent an interior of a building. In the illustrated example, a user interface (e.g., presented via a user device) is depicting a representation of an interior. The interior includes one or more rooms. As described herein, the building model may be textured based on use of generative machine learning techniques and a prompt (e.g., a visual prompt, auditory prompt, textual prompt, and so on). For example, the building model may be iteratively rotated (e.g., from a point of view from the exterior to the interior) and for each rotation a texture may be generated and applied to the model. As another example, the building model may be iteratively rotated (e.g., from a point of view from the interior to the exterior) and for each rotation a texture may be generated and applied to the model.

FIG. 2A illustrates a system 200 configured for iteratively texturing a three-dimensional model with consistent predictions, in accordance with one or more implementations. The system 200 may be, for example, the building generation system 100. In some implementations, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of model providing module 208, texture generating module 210, portion texturing module 212, viewpoint change applying module 214, extension texture generating module 216, texture extension texture display module 218, and/or other instruction modules.

Model providing module 208 may be configured to provide a three-dimensional model. The three-dimensional model may be a partial three-dimensional model. The three-dimensional model may include adjustable geometries. The first parameter may accommodate the adjustable geometries. The second parameter may accommodate the adjustable geometries.

The geometry may be adjustable by the one or more machine learning models. The three-dimensional model may include fixed geometries. The first parameter may be based on the fixed geometries. The second parameter may be based on the fixed geometries. The first parameter may include a depth control signal associated with the three-dimensional model.

Texture generating module 210 may be configured to generate a first texture for the three-dimensional model from a first viewpoint perspective (e.g., viewpoint angle). Generating the first texture may further include providing the first parameter. Providing the first parameter may be by the one or more machine learning models. The first texture may be generated via one or more machine learning models and at least one first parameter.

Portion texturing module 212 may be configured to texture a select portion of the three-dimensional model with the first texture. Portion texturing module 212 may be configured to texture an expanded portion of the three-dimensional model with the extension texture. Viewpoint change applying module 214 may be configured to apply a viewpoint change to the three-dimensional model.

Extension texture generating module 216 may be configured to generate an extension texture for the three-dimensional model from the viewpoint change. Generating the extension texture may further include providing the second parameter. Providing the second parameter may be by the one or more machine learning models. The extension texture may be generated via one or more machine learning models and at least one second parameter. Texture extension texture display module 218 may be configured to display the three-dimensional with the first texture and extension texture.

In some implementations, the first parameter may include a texture prompt. In some implementations, the texture prompt may be based on a text-based input. In some implementations, the texture prompt may be based on a visual input.

In some implementations, computing platform(s) 202, remote platform(s) 204, and/or external resources 220 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 220 may be operatively linked via some other communication media.

A given remote platform 204 may include one or more processors configured to execute computer program modules. The computer program modules may be configured to enable an expert or user associated with the given remote platform 204 to interface with system 200 and/or external resources 220, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 220 may include sources of information outside of system 200, external entities participating with system 200, and/or other resources. In some implementations, some or all of the functionality attributed herein to external resources 220 may be provided by resources included in system 200.

Computing platform(s) 202 may include electronic storage 222, one or more processors 224, and/or other components. Computing platform(s) 202 may include communication lines, or ports to enable the exchange of information with a network and/or other computing platforms. Illustration of computing platform(s) 202 in FIG. 2A is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 222 may comprise non-transitory storage media that electronically stores information. The electronic storage media of electronic storage 222 may include one or both of system storage that is provided integrally (e.g., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 222 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 222 may include one or more virtual storage resources (e.g., cloud storage, a virtual private network, and/or other virtual storage resources). Electronic storage 222 may store software algorithms, information determined by processor(s) 224, information received from computing platform(s) 202, information received from remote platform(s) 204, and/or other information that enables computing platform(s) 202 to function as described herein.

Processor(s) 224 may be configured to provide information processing capabilities in computing platform(s) 202. As such, processor(s) 224 may include one or more of a digital processor, an analog processor, a digital circuit designed to process information, an analog circuit designed to process information, a state machine, and/or other mechanisms for electronically processing information. Although processor(s) 224 is shown in FIG. 2A as a single entity, this is for illustrative purposes only. In some implementations, processor(s) 224 may include a plurality of processing units. These processing units may be physically located within the same device, or processor(s) 224 may represent processing functionality of a plurality of devices operating in coordination. Processor(s) 224 may be configured to execute modules 208, 210, 212, 214, 216, and/or 218, and/or other modules. Processor(s) 224 may be configured to execute modules 208, 210, 212, 214, 216, and/or 218, and/or other modules by software; hardware; firmware; some combination of software, hardware, and/or firmware; and/or other mechanisms for configuring processing capabilities on processor(s) 224. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, and/or 218 are illustrated in FIG. 2A as being implemented within a single processing unit, in implementations in which processor(s) 224 includes multiple processing units, one or more of modules 208, 210, 212, 214, 216, and/or 218 may be implemented remotely from the other modules. The description of the functionality provided by the different modules 208, 210, 212, 214, 216, and/or 218 described below is for illustrative purposes, and is not intended to be limiting, as any of modules 208, 210, 212, 214, 216, and/or 218 may provide more or less functionality than is described. For example, one or more of modules 208, 210, 212, 214, 216, and/or 218 may be eliminated, and some or all of its functionality may be provided by other ones of modules 208, 210, 212, 214, 216, and/or 218. As another example, processor(s) 224 may be configured to execute one or more additional modules that may perform some or all of the functionality attributed below to one of modules 208, 210, 212, 214, 216, and/or 218.

FIG. 2B is a flowchart of an example process 200 for iteratively texturing a three-dimensional model with consistent predictions, in accordance with one or more implementations. The operations of process 200 presented below are intended to be illustrative. In some implementations, process 200 may be accomplished with one or more additional operations not described, and/or without one or more of the operations discussed. Additionally, the order in which the operations of process 200 are illustrated in FIG. 2B and described below is not intended to be limiting. The process 200 may be performed, for example, via a system (e.g., building generation system 100).

At block 202, the system provides a three-dimensional model. Block 202 may be performed by one or more hardware processors configured by machine-readable instructions including a module that is the same as or similar to model providing module 208, in accordance with one or more implementations.

At block 204, the system generates a first texture for the three-dimensional model from a first viewpoint perspective. The first texture may be generated via one or more machine learning models and at least one first parameter. Block 204 may be performed by one or more hardware processors configured by machine-readable instructions including a module that is the same as or similar to texture generating module 210, in accordance with one or more implementations.

At block 206, the system textures a select portion of the three-dimensional model with the first texture. Operation 206 may be performed by one or more hardware processors configured by machine-readable instructions including a module that is the same as or similar to portion texturing module 212, in accordance with one or more implementations.

At block 208, the system applies a viewpoint change to the three-dimensional model. Operation 208 may be performed by one or more hardware processors configured by machine-readable instructions including a module that is the same as or similar to viewpoint change applying module 214, in accordance with one or more implementations.

At block 210, the system generates an extension texture for the three-dimensional model from the viewpoint change. The extension texture may be generated via one or more machine learning models and at least one second parameter. Operation 210 may be performed by one or more hardware processors configured by machine-readable instructions including a module that is the same as or similar to extension texture generating module 216, in accordance with one or more implementations.

At block 212, the system textures an expanded portion of the three-dimensional model with the extension texture. Operation 212 may be performed by one or more hardware processors configured by machine-readable instructions including a module that is the same as or similar to portion texturing module 212, in accordance with one or more implementations.

At block 214, the system displays the three-dimensional model with the first texture and extension texture. For example, the display may occur via a user interface presented on a user device. Operation 214 may be performed by one or more hardware processors configured by machine-readable instructions including a module that is the same as or similar to texture extension texture display module 218, in accordance with one or more implementations.

### Block Diagram/Flowcharts—Generating Additional Geometry

FIG. 3A is a block diagram of an example building generation system 100 generating a scene 310 with geometry based on a prompt 304. In some embodiments, the scene 310 may be a three-dimensional scene. As described herein, the building generation system 100 may allow for generation of scenes with content based on input of a prompt 304 from a user. In some embodiments, the content may be three-dimensional content. The three-dimensional content may include a three-dimensional building model 302 and additional three-dimensional geometry generated based on the prompt 104. The building model 302 may be, as described herein, an exterior or interior of a building. In some embodiments, the building model 302 may encompass both an exterior and an interior. For example, a user may iteratively update textures and/or geometry for both the exterior and interior. As an example, the user may adjust geometry which affects both the exterior and interior (e.g., adding a wing, removing a fireplace).

In the illustrated example, the prompt 304 is to add a rock garden with a grassy area that includes a tree. The prompt 304 may be provided to an input portion on an application or web page. For example, and as described herein, the building generation system 100 may be in communication with a system configured to provide a user interface to a user via a web page. As another example, the building generation system 100 may execute a web application to which users may communicate. While a textual prompt is illustrated in FIG. 3A, additional or different prompts may be used and fall within the scope of the disclosure herein. For example, a visual prompt may be provided. In this example, the visual prompt may graphically indicate the geometry change that is requested. As an example, the visual prompt may include an image of a building with specific geometry distinctions. As anther example, the visual prompt may include landscaping features (e.g., the visual prompt may include an image of a rock garden, a tree, and so on). As another example, an auditory prompt may be provided.

As described herein, the building generation system 100 may successively generate the scene 310 by registering, or otherwise adjusting, viewpoint changes of the scene 310. For example, and as illustrated, the building generation system 100 may generate a rendering of the scene (referred to as viewpoint A 310) which corresponds to an example viewpoint angle referred to as viewpoint angle A). In this example, the building generation system 100 may render the three-dimensional building model 302 at viewpoint angle A.

The machine learning model may output a texture for the scene at viewpoint angle A. As described herein, the texture may be generated based on a forward pass through the machine learning model using viewpoint A 310 and the prompt 304. In some embodiments, the texture may be based on geometry, such as depth information, of the three-dimensional building model 302. As an example described herein, the depth information may represent a control signal used by the machine learning model to inform the generation of the texture. In this way, the texture may be consistent with the depth (e.g., contours, boundaries, and so on) of the three-dimensional building model 302. In some embodiments, the three-dimensional building model 302 may have a texture associated with it.

The texture may additionally include image content associated with the prompt 304. In the illustrated example, viewpoint A 310A includes image content in accordance with the prompt 304. For example, the building generation system 100 may generate texture(s) reflecting the prompt 304. As described herein, the image content may not have depth information associated with it. Thus, in some embodiments the building generation system 300 may execute a machine learning model to determine depth. For example, a monocular depth estimation technique may be used to determine, or otherwise extract, depth associated with the image content. In this way, geometry of the image content may be extracted.

As described herein, the building generation system 100 may then register, or otherwise adjust, the viewpoint. For example, the building generation system 100 may adjust the viewpoint angle to rotate the scene via a threshold angle (e.g., 2, degrees, 5 degrees, 10 degrees). In this example, the building generation system 100 may thus rotate the geometry associated with the scene (e.g., the model 302, the depth information associated with the image content).

FIG. 3B is a detailed block diagram of the example building generation system 100. As described in FIG. 3A, the building generation system 110 generates a rendering of the scene at viewpoint angle A (referred to above as viewpoint A 310A). The rendering may include image content (e.g., textures) generated by a machine learning model based on the prompt 304. Additionally, the rendering may be associated with geometry (e.g., geometry associated with the model 302 and the image content based on the prompt 304).

The building generation system 100 includes a geometry extraction engine 320 to output generated geometry 312A for viewpoint A 310A. For example, the geometry generation engine 320 may perform a monocular depth estimation to output the generated geometry 312A (e.g., depth information) for the image content generated based on the prompt 304.

The building generation system 100 further includes a scene generation engine 330 which obtains viewpoint B 310B by rendering the scene at viewpoint angle B. As described herein, the building generation system 100 may cause rotation of the scene via a threshold amount (e.g., from viewpoint angle A to viewpoint angle B). Due to this rotation, the scene may lack image content for portions which are visible in viewpoint B 310B but not in viewpoint A. For example, the scene may lack image content at viewpoint angle B for portions of the image content which were generated based on the prompt 304. The scene generation engine 330 may thus represent a machine learning model (e.g., the generative model described herein) which outputs image content for viewpoint B 310B.

As an example, the scene generation engine 330 may use geometry as a control signal. For this example, the geometry may reflect the geometry of the three-dimensional building model 302 along with the generated geometry 312A. Optionally, the scene generation engine 330 may use in-painting techniques to determine portions of viewpoint B 310B which are to be filled in (e.g., generated with textures) by the scene generation engine 330. As an example, viewpoint B 310B may include a portion of a tree. For this example, the portion of the tree may have been generated for viewpoint A 310A. When adjusting the viewpoint angle to viewpoint angle B, viewpoint B may therefore include this portion of the tree as rendered from viewpoint angle B. Thus, inpainting may be used to fill in the remainder of the tree that would be visible at viewpoint angle B. Using the depth information as a control signal, along with the prompt and viewpoint A 310A, the scene generation engine 330 may therefore output viewpoint B 310B. While viewpoint A 310A and building model 302 are illustrated as being provided separately, in some embodiments the viewpoint A 310A and building model 302 form the same data or information (e.g., texture information generated for viewpoint A 310A may be applied to building model 302).

As described herein, the building generation system 100 may successively rotate the scene via a threshold angle or set of angles. At each angle, the building generation system 100 may output a viewpoint rendering based on one or more prior viewpoint renderings. In this way, the building generation system 100 may generate a fully rotatable three-dimensional scene, for example for presentation to the user. The scene may include textures, and associated geometry, for the model 302 and features added based on the prompt 304.

FIG. 4 is a flowchart of an example process 400 for generating a scene based on a prompt indicating additional geometry for inclusion in the scene. For convenience, the process 400 will be described as being performed by a system of one or more computers (e.g., the building generation system 100).

At block 402, the system receives a prompt requesting additional geometry for a scene that includes a building. As described herein, the prompt may represent a textual, visual, auditory, and so on, prompt.

At block 404, the system extracts geometry associated with a three-dimensional model of the building. The system may receive depth information, for example as a depth map, line map, segmentation mask, and so on. The system may also analyze images of the building and generate the three-dimensional model of the building.

At block 406, the system generates a first viewpoint via rendering the scene from a first viewpoint angle. Based on the three-dimensional model of the building and the prompt, the system generates image content to be added to the first viewpoint. For example, the system renders the three-dimensional model of the building from the first viewpoint angle. The rendering is provided with the prompt as input to a machine learning model. The system then computes a forward pass through the machine learning model to generate the first viewpoint with image content reflecting the prompt. In some embodiments, the depth information associated with the three-dimensional building model (e.g., a portion of the depth information associated with the first viewpoint angle) is provided to the machine learning model as a control signal.

At block 408, the system extracts updated geometry for the first viewpoint. The system may perform a monocular depth estimation technique to extract geometry of the image content generated based on the prompt. Thus, the updated geometry may include geometry of the added image content. As an example with respect to a prompt which requests inclusion of landscaping features, the updated geometry may include the geometry of the landscaping features from the first viewpoint angle.

At block 410, the system generates a second viewpoint via rendering the scene from a second viewpoint angle. As described in FIGS. 1A-1B, the system may rotate the scene via an angle. For example, the system may register a viewpoint change to correspond to the rotated angle. The system then provides the geometry associated with the first viewpoint as a control signal along with the prompt and the second viewpoint to the machine learning model. In this way the system may obtain the image scene from the second viewpoint angle.

The system iteratively adjusts the viewpoint angle until it obtains a 360-degree view, or substantially 360-degree view, about the building. The resulting three-dimensional scene may then be viewed via a user interface. Additionally, a user may provide user input to cause rotation of the scene. As described herein, the system may generate individual viewpoints for individual viewpoint angles. Thus, the user may rotate the scene to correspond with a particular viewpoint angle which was not explicitly used by the system to form the 360-degree view. The system may optionally interpolate between viewpoints for viewpoint angles proximate to the particular viewpoint angle.

The description herein focused on adding geometry to a scene which includes a building, such as a user's domicile. In some embodiments, the system described herein may separate the scene into a background, subject, and foreground component. For example, the system may generate an image which is aligned with the three-dimensional model. In this example, the generated image may include contextually relevant elements such as landscaping. Thus, the system may receive selection, or input, identifying specific contextual elements to include.

The system may separate the generated image into background, subject, and foreground components. In this way, the user may separately adjust these components. With respect to the subject, the system may generate segment a building from the image based on a mask applied to the image. Thus, the building may represent the subject component. The system may then use a machine learning model to find additional elements, such as landscaping which are overlapping with the building. These overlapping elements may then be assigned foreground components. The background may similarly represent elements separate from the building which are not overlapping with the building.

The system may then use a machine learning model to separately adjust the background, subject, and/or foreground elements. As may be appreciated, certain elements may cast a shadow on the subject (e.g., building). The machine learning model may be trained to generate new elements which have updated shadows on the subject.

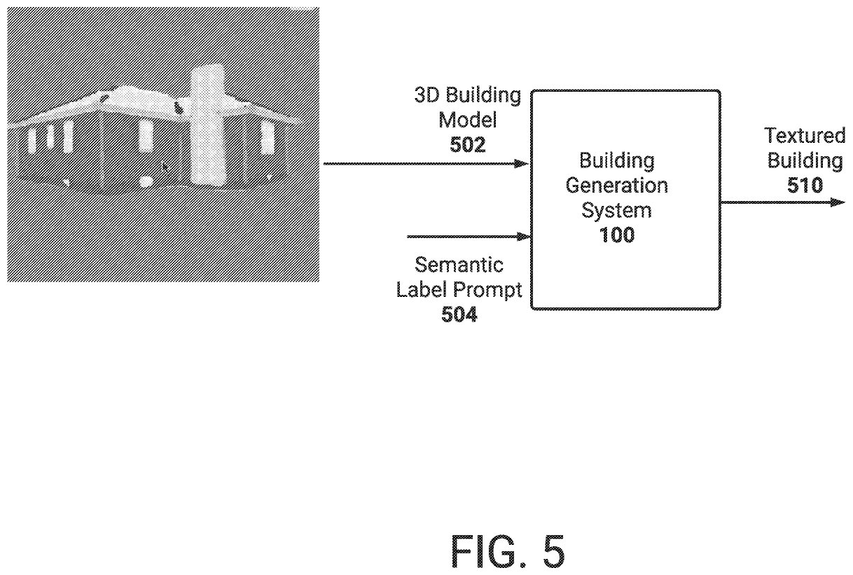

FIG. 5 is a block diagram of the building generation system 100 generating a textured building 510 based on a semantic prompt 504. In some embodiments, the system 100 may allow for updating a building model 502 based on semantic classes. In the illustrated example, the semantic classes may include a window, a wall, a roof, a gable, a chimney, a garage door, a door, and so on. Thus, the system 100 may be trained to recognize these semantic classes on input buildings. Thus, the building model 502 may be assigned colors which are indicative of specific semantic classes.

The system 100 may receive a prompt 504 which indicates an adjustment to be made to the building 502 based on semantic classes. For example, a user may assign a portion of the building model 502 as a particular color which corresponds to a particular semantic class. The system 100 may then update the building model 502 based on the prompt 504. For example, if the user assigned the portion as being a door, then the system 100 may update the portion to correspond with a door.

In this way, the system 100 may allow for updating of the user's building (e.g., house) based on semantic classifications. For example, the user may rapidly mockup, or otherwise view, possible changes to his/her house.

Similar to FIGS. 3A-4, the system 100 may allow for the user to create new geometry. For example, the prompt 504 may cause a new porch to be generated. In this example, the new porch may be viewed as an image by the user. The system 100 may extract geometry of the new porch, for example via monocular depth estimation, and then register a viewpoint change. As described herein, the system may use the depth information as a control signal and generate a view of the building and new porch at the viewpoint change.

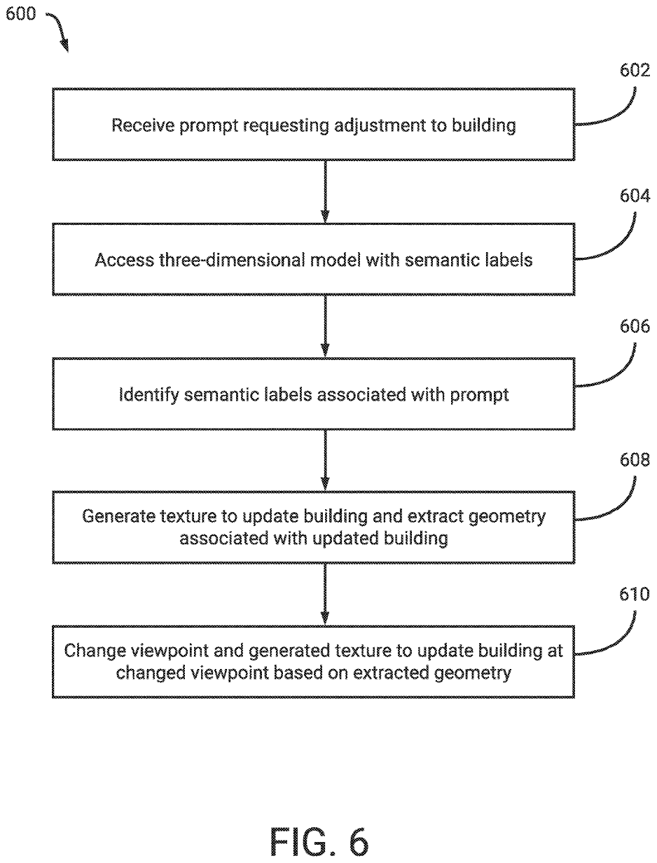

FIG. 6 is a flowchart of an example process 600 for generating textures to update a building based on a semantic prompt. For convenience, the process 600 will be described as being performed by a system of one or more computers (e.g., the building generation system 100).

At block 602, the system receives a prompt requesting adjustment to a building. As described herein, the prompt may indicate an adjustment based on semantic labels or classifications of a building.

At block 604, the system accesses a three-dimensional model of the building which is associated with semantic labels.

At block 606, the system identifies semantic labels associated with the prompt. The prompt may include a textual description of a semantic label change, or a new semantic label to include in the model. The prompt may additionally represent user input provided to the model to assign a semantic label. For example, a user may update a semantic label to a new semantic label. As another example, the user may draw new geometry and assign the geometry with a semantic label.

At block 608, the system generates textures associated with the building. The system may use a machine learning model to generate textures which correspond to the prompt. These generated textures may optionally correspond to a particular viewpoint.

At block 610, the system changes viewpoint. As described herein, the system may change the viewpoint associated with the generated textures. The system may then generate textures which correspond to the changed viewpoint. Similarly, the system may successively generate textures until a substantially 360-degree view of the building is obtained.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the herein-described embodiments, the elements of which are to be understood as being among other acceptable examples. All such modifications and variations are intended to be included herein within the scope of this disclosure.

What is claimed is:

1. A method of iteratively texturing a three-dimensional model with consistent predictions, the method comprising:
providing a three-dimensional model;
generating a first texture for the three-dimensional model from a first viewpoint perspective, wherein the first texture is generated via one or more machine learning models and at least one first parameter;
texturing a select portion of the three-dimensional model with the first texture;
applying a viewpoint change to the three-dimensional model;
generating an extension texture for the three-dimensional model from the viewpoint change, wherein the extension texture is generated via one or more machine learning models and at least one second parameter; and
texturing an expanded portion of the three-dimensional model with the extension texture; and
displaying the three-dimensional with the first texture and extension texture.

2. The method of claim 1, wherein the three-dimensional model is a partial three-dimensional model.

3. The method of claim 1, wherein the three-dimensional model comprises adjustable geometries.

4. The method of claim 3, wherein the first parameter accommodates the adjustable geometries.

5. The method of claim 3, wherein the second parameter accommodates the adjustable geometries.

6. The method of claim 3, wherein the geometry is adjustable by the one or more machine learning models.

7. The method of claim 1, wherein the three-dimensional model comprises fixed geometries. The method of claim 7, wherein the first parameter is based on the fixed geometries.

9. The method of claim 7, wherein the second parameter is based on the fixed geometries.

10. The method of claim 1, wherein generating the first texture further comprises providing the first parameter.

11. The method of claim 10, wherein providing the first parameter is by the one or more machine learning models.

12. The method of claim 1, wherein generating the extension texture further comprises providing the second parameter.

13. The method of claim 12, wherein providing the second parameter is by the one or more machine learning models.

14. The method of claim 1, wherein the first parameter comprises a texture prompt.

15. The method of claim 14, wherein the texture prompt is based on a text-based input.

16. The method of claim 14, wherein the texture prompt is based on a visual input.

17. The method of claim 1, wherein the first parameter comprises a depth control signal associated with the three-dimensional model.

18. The method of 17, wherein the depth control signal is based on the first viewpoint perspective.

19. The method of claim 1, wherein the first parameter comprises a line segment signal comprising line segments of the three-dimensional model.

20. The method of claim 19, wherein the line segment signal is based on the first viewpoint perspective.

21. The method of claim 1, wherein the first parameter comprises a segmentation mask of the three-dimensional model.

22. The method of claim 21, wherein the segmentation mask is based on the first viewpoint perspective.

23. The method of claim 21, wherein the segmentation mask comprises a semantic segmentation mask.

24. The method of claim 1, wherein the second parameter comprises a texture prompt.

25. The method of claim 24, wherein the texture prompt is based on a text-based input.

26. The method of claim 24, wherein the texture prompt is based on a visual input.

27. The method of claim 26, wherein the visual prompt is based on the first texture.

28. The method of claim 1, wherein the second parameter comprises a depth control signal associated with the three-dimensional model.

29. The method of 28, wherein the depth control signal is based on the viewpoint change.

30. The method of claim 1, wherein the second parameter comprises a line segment signal comprising line segments of the three-dimensional model.

31. The method of claim 30, wherein the line segment signal is based on the viewpoint change.

32. The method of claim 1, wherein the second parameter comprises a segmentation mask of the three-dimensional model.

33. The method of claim 32, wherein the segmentation mask is based on the viewpoint change.

34. The method of claim 32, wherein the segmentation mask comprises a semantic segmentation mask.

35. The method of claim 1, wherein the select portion comprises untextured pixels of the three-dimensional model from the first viewpoint perspective.

36. The method of claim 1, wherein the select portion comprises classified pixels provided by a semantic segmentation model.

37. The method of claim 1, wherein the select portion comprises pixels within a fixed distance from a render camera viewing the three-dimensional model from the first viewpoint perspective.

38. The method of claim 36, wherein the fixed distance is associated with a depth map of the three-dimensional model from the first viewpoint perspective.

39. The method of claim 1, wherein the expanded portion comprises untextured pixels of the three-dimensional model from the viewpoint change.

40. The method of claim 1, wherein the expanded portion comprises classified pixels provided by a semantic segmentation model.

41. The method of claim 1, wherein the expanded portion comprises pixels within a fixed distance from a render camera viewing the three-dimensional model from the viewpoint change.

42. The method of claim 41, wherein the fixed distance is associated with a depth map of the three-dimensional model from the viewpoint change.

43. The method of claim 1, wherein the viewpoint change comprises a perspective change.

44. The method of claim 43, wherein the perspective change comprises a rotation change of the three-dimensional model relative to a render camera viewing the three-dimensional model.

45. The method of claim 44, wherein the rotation change is greater than five degrees.

46. The method of claim 1, wherein the viewpoint change comprises a translation change.

47. The method of claim 46, where in the translation change is a zoom effect relative to the three-dimensional model.

48. The method of claim 46, wherein the translation change is greater than ten pixels.

49. The method of claim 1, wherein the viewpoint change is based on user input.

50. A system configured to perform any one of claims 1-49.

51. One or more non-transitory computer readable medium comprising instructions to execute any one of claims 1-49.

52. A method implemented by a system of one or more processors, the method comprising:
accessing a three-dimensional model associated with a building, the three-dimensional model being associated with geometry which is included in a scene;
generating, via one or more machine learning models, a first viewpoint of the scene from a first viewpoint angle, the first viewpoint including textures applied to the three-dimensional model from the first viewpoint angle and additional image content generated based on at least one parameter;
extracting, via one or more machine learning models, updated geometry for inclusion in the scene, wherein the updated geometry includes geometry associated with the additional image content at the first viewpoint angle; and
generating, via one or more machine learning models, a second viewpoint of the scene from a second viewpoint angle, where generating the second viewpoint is based on the updated geometry.

53. The method of claim 52, wherein the at least one parameter comprises a prompt indicative of features to be added to the scene.

54. The method of claim 53, wherein the prompt is based on a text-based input.

55. The method of claim 53, wherein the prompt is based on a visual input.

56. The method of claim 53, wherein the scene is associated with inclusion of the features proximate to the building.

57. The method of claim 56, wherein the features include landscaping features.

58. The method of claim 53, wherein the scene is updated to add geometry associated with the features.

59. The method of claim 52, further comprising causing presentation, via a user interface, of the first viewpoint.

60. The method of claim 52, further comprising causing presentation, via a user interface, of the second viewpoint.

61. The method of claim 52, further comprising causing presentation, via a user interface, of the scene, wherein the user interface responds to user input associated with rotation of the scene, and wherein based on rotation to a third viewpoint angle the system is configured to generate the third viewpoint.

62. The method of claim 52, wherein the system generates individual viewpoints for a set of viewpoint angles.

63. The method of claim 62, further comprising:
receiving user input associated with selection of a particular viewpoint angle; and
generating, based on the viewpoints, a particular viewpoint from the particular viewpoint angle.

64. The method of claim 63, wherein the particular viewpoint angle is included in the set of viewpoint angles.

65. The method of claim 63, wherein the particular viewpoint angle is not included in the set, and wherein the particular viewpoint is generated based on interpolation of a subset of the viewpoints.

66. The method of claim 63, wherein the particular viewpoint angle is not included in the set, and wherein the particular viewpoint is generated based on a subset of the generated viewpoints which are input into the one or more machine learning models.

67. The method of claim 52, wherein the geometry associated with the three-dimensional model is a line map in which line edges are assigned a particular color.

68. The method of claim 52, wherein the geometry associated with the three-dimensional model is a depth map.

69. The method of claim 52, wherein the geometry associated with the three-dimensional model is a segmentation mask.

70. The method of claim 69, wherein the segmentation mask is a semantic segmentation mask.

71. The method of claim 52, wherein the textures are applied to the geometry associated with the additional image content.

72. The method of claim 52, wherein the updated geometry and geometry associated with the three-dimensional model are as control information to the one or more machine learning models.

73. The method of claim 52, wherein extracting updated geometry comprises:
computing a forward pass of the first viewpoint through the one or more machine learning models, wherein at least one of the machine learning models is trained to perform monocular depth estimation and configured to output geometry associated with an input image.

74. The method of claim 73, wherein the output geometry comprises a line map, a depth map, or a segmentation mask.

75. The method of claim 52, wherein generating the second viewpoint comprises:
obtaining a rendering of the scene at the second viewpoint angle;
inputting the rendering and geometry associated with the scene at the second viewpoint angle into the one or more machine learning models; and
obtaining the second viewpoint, the second viewpoint including, at least, additional image content generated based on the at least one parameter.

76. The method of claim 75, wherein the input geometry includes at least portions of the updated geometry and geometry associated with the three-dimensional building at the second viewpoint angle.

77. The method of claim 75, wherein the obtained second viewpoint comprises textures to be applied to the scene.

78. The method of claim 75, wherein inpainting information is associated with at least some portions of the second viewpoint which do not have associated geometry.

79. The method of claim 78, wherein the inpainting information causes generation of extension textures to the portions.

80. The method of claim 78, wherein geometry associated with the additional image content is extracted to form updated geometry.

81. The method of claim 78, wherein the inpainting information is associated with the portions based on the portions have greater than a threshold resolution.

82. The method of claim 52, wherein the scene is a three-dimensional scene, and wherein the three-dimensional scene is configured for inclusion in a user interface.

83. A system comprising one or more computers and non-transitory computer storage media storing instructions that when executed by the one or more computers, cause the one or more computers to perform the method of claims 52-82.

84. Non-transitory computer storage media storing instructions that when executed by a system of one or more computers, cause the one or more computers to perform the method of claims 52-82.

85. A method implemented by a system of one or more processors, wherein the system generates a user interface for presentation via a user device, and wherein the user interface:
requests a textual or visual prompt indicative of features to be included in a three-dimensional scene, and receives input of a three-dimensional model associated with a building;
triggers generation of viewpoints of the scene from a plurality of viewpoint angles, wherein the viewpoints represent image rendering of the scene, and wherein the three-dimensional model is associated with geometry, wherein the system is configured to:
generate, via one or more machine learning models, individual viewpoints from individual viewpoint angles,
wherein the machine learning models are input textures applied to geometry which form the scene from an individual viewpoint angle, wherein the geometry is determined using the three-dimensional model and geometry extracted from additional image content generated using the machine learning models for one or more prior viewpoint angles; and
presents at least one of the viewpoints.

86. The method of claim 85, wherein the prompt is descriptive of the scene as adjusting the building or a surrounding of the building.

87. The method of claim 86, wherein surrounding of the building reflects landscaping proximate to the building.

88. The method of claim 85, wherein the user interface responds to user input associated with rotation of the scene.

89. The method of claim 85, wherein the geometry extracted from additional image content is extracted using monocular depth estimation.

90. The method of claim 85, wherein the image content from an individual viewpoint angle is an image reflecting a rendering of the scene from the individual viewpoint angle.

91. The method of claims 85, wherein the visual prompt reflects a desired scene, and wherein the desired scene is analyzed to extract attributes which are used by the machine learning models.

92. A method implemented by a system of one or more processors, the method comprising:
accessing a three-dimensional model associated with a building, the three-dimensional model being associated with geometry and semantic labels;
generating, via one or more machine learning models, textures to be applied to the three-dimensional model, wherein generating textures is based on at least one parameter, and wherein the parameter is analyzed to identify particular semantic labels which are input into the one or more machine learning models;
in response to a viewpoint change, extracting, via one or more machine learning models, updated geometry based on the generated textures and the geometry associated with the three-dimensional model, wherein the updated geometry includes additional geometry reflective of a portion of the textures associated with the at least one parameter; and
generating, via one or more machine learning models, textures to be applied to the updated geometry.

93. The method of claim 92, wherein the parameter is indicative of a prompt associated with adjusting the building.

94. The method of claim 92, wherein the prompt is a textual prompt requesting addition to, or deletion of, a portion of the building associated with at least one semantic label.

95. The method of claim 92 wherein the prompt is a visual prompt requesting addition to, or deletion of, a portion of the building associated with at least one semantic label, wherein the portion is selected via a user interface.

96. The method of claim 95, wherein the at least one semantic label is selected via the user interface.

97. The method of claim 92, wherein the semantic labels include a window, a door, a garage, a chimney, a porch, or a door.

98. The method of claim 92, wherein the image scene is configured for presentation via a user interface.

99. The method of claim 98, wherein the image scene is configured to be rotated via the user interface.

100. The method of claim 92, wherein the geometry represents a line map or a depth map.

101. The method of claim 100, wherein the geometry is used as a control signal.

102. The method of claim 92, wherein individual semantic labels are assigned individual colors, and wherein the at least one parameter indicates selection of at least one color.

103. The method of claim 102, wherein the one or more machine learning models generate the portion of the textures based on assignment of a corresponding portion of the three-dimensional model as the at least one color.

104. A system comprising one or more computers and non-transitory computer storage media storing instructions that when executed by the one or more computers, cause the one or more computers to perform the method of claims 92-103.

105. Non-transitory computer storage media storing instructions that when executed by a system of one or more computers, cause the one or more computers to perform the method of claims 92-103.

106. A method implemented by a system of one or more processors, the method comprising:
accessing a three-dimensional model which is associated with a depth map;
generating a texture for the three-dimensional model via one or more machine learning models based on a prompt indicative of the texture, wherein the one or more machine learning models generate texture portions which form the texture based on a plurality of views of the three-dimensional model, and wherein generating the texture portions comprises iteratively:
generating an individual texture portion via the one or more machine learning models based on input comprising the prompt, an individual portion of the depth map which is associated with an individual view of the three-dimensional model, an individual rendering of the three-dimensional model at the individual view which includes a previously applied texture portion,
wherein the individual texture portion is applied to the three-dimensional model at least a subset of positions for which a texture portion has not been applied,
wherein the three-dimensional model is configured for presentation.

107. The method of claim 106, wherein the individual views encompass a 360-degree view of the three-dimensional model.

108. The method of claim 106, wherein the one or more machine learning models use the individual portion of the depth map as control information.

109. The method of claim 106, wherein the subset of positions includes positions which are less than a threshold distance from a render camera that generates the individual rendering.

110. The method of claim 106, wherein the input further comprises information identifying the at least a subset of positions of the individual rendering for which a texture portion has not been applied.

111. The method of claim 106, further comprising presenting the three-dimensional model via an interactive user interface.

112. The method of claim 111, wherein the three-dimensional model is rotatable based on input to the interactive user interface.
